(19) United States
(12) Patent Application Publication
(10) Pub. No.: US 2001/0029604 A1
(43) Pub. Date: Oct. 11, 2001

(54) Descriptive data construct mapping method and apparatus

(76) Inventors: Jacob Dreyband, Los Gatos, CA (US); Leonid Nilva, San Jose, CA (US); Michael Shapiro, San Jose, CA (US)

Correspondence Address: Kevin H. Fortin, BURNS, DOANE, SWECKER & MATHIS, L.L.P., P.O. Box 1404, Alexandria, VA, 22313-1404, US

(21) Appl. No.: 09/844,993

(22) Filed: Apr. 27, 2001

(51) Int. Cl. G06F 9/45

(52) U.S. Cl. 717/7

(57) ABSTRACT

The present invention provides a method and apparatus for mapping a descriptive language including a data description having a structure complexity into an object oriented data presentation includes identifying the data description and creating an object oriented class including an internal static class, wherein the internal static class corresponds to the structure complexity of the data description. A feature of the present invention is a method for mapping a Schema including a structural complexity into an object oriented language including a functionality to provide a one to one correspondence between the structural complexity of the semantical language and the functionality of the object oriented language. Another aspect of the present invention provides a computer readable medium containing programming which when executed performs the following procedures including: identifying a data description and creating an object oriented class including an internal static class, wherein the internal static class corresponds to a structure complexity of the data description.

### BACKGROUND OF THE INVENTION

1. Field of the Invention

The present invention relates generally to relational databases and object-oriented programming, and more particularly to mapping a descriptive data construct into an object oriented programming language.

2. Brief Description of the Related Art

In the Internet revolution, common rules are being developed by such organizations as the World Wide Web Consortium (“W3C”). W3C has defined extensible Markup Language (“XML”) as the open standard for describing data. XML is being touted as the panacea to e-commerce. XML is a data description that defines data elements on Web pages and in business-to-business documents. XML provides tags to be defined by the Web page developer which allow for data to be identified, such as product information, so that the Web page can now function like a database record. XML tags are normally defined in an XML Schema. The XML Schema defines the content type as well as the name whereas XML defines what the data is.

Schema language is a descriptive programming language which semantically describes how to write XML files. The term “Schema” is used in describing the structure for both relational databases and object oriented programming databases. XML Schema conforms to a set of established semantical rules.

Object oriented programming (OOP) incorporates a self-contained module of data called an object and its associated processing. OOP focuses on the objects that the programmers want to manipulate as opposed to the logic required to manipulate the data. The objects can range from a person (described by a name, a date of birth, an address, etc.) to buildings and floors (whose properties can be described and managed) down to icons on a computer desktop (such as buttons and scroll bars). An object technology instance is defined as a member of a class; such as “John” is an instance of the class “person”. The initial values of the instance variables are assigned when the instance is created.

The underlying constructs of an object oriented language, like Java, C++ and Smalltalk, are very similar to the structures within the Schema language. Mapping the Schema language into an object oriented language combines the relational aspects of Schema with the functional aspects of the OOP. The solution to the developers dilemma resides in combining the semantical relationships contained within a descriptive language with the functionality of object oriented programming, for example creating object oriented code out of the XML Schema. Thus a Schema mapped OOP would be a likely solution to the problems with portability.

Developers are trying to represent the hierarchical structure of complex classes within the Schema language in Java and other object oriented languages. One problem is that Schema relational elements are not always exactly reproducible by object oriented programming. This is because the current state of the art lacks the ability to effectively map a semantically descriptive language, such as Schema, into an object oriented language, such as Java, without losing the relational characteristics of complex data structures.

The current attempts have mapped a portion of the Schema and avoid the structures which do not match the OOP. The problem with this approach is that XML is an unlimited language, meaning that it can cover almost anything with labels and the combination of such labels. The Schema standard came from the combination of two different programming worlds: relational database programming and object oriented programming. The several attempts that have been made to map these constructs into known programming languages constructs, thus compiling the Schema into java classes, or into C++ classes, still have been unable to retain the full capabilities of the Schema.

Because attempts have failed in mapping the full XML Schema into an object oriented language, the developers have fallen back onto an old standard of semantical representation called Document Type Definition (“DTD”). It is a language that describes the contents of documents. An example of one such attempt is the “Zeus” project for open source Java and data binding sponsored by Lutris Technologies, Inc. Zeus is used to generate Java classes from an XML DTD. The problem with using DTD is that unlike DTD, XML Schemas are written in XML syntax, which is more verbose than DTD. XML Schemas include many enhanced features and can be created with any XML tools. As such, XML Schema, seen as the advanced superset of DTD, is expected to eventually replace DTD.

Accordingly, it is desirable to provide a method and apparatus which can process any valid text in a descriptive language and automatically create object oriented files, with the capability of mapping the entire Schema into the object oriented language. It is also desirable to provide an apparatus and method that processes XML text in Schema language and creates Java classes to process the valid XMLs for that Schema definition without any exclusions.

### SUMMARY OF THE INVENTION

The present invention overcomes the shortcomings of the prior art by providing a method for mapping a descriptive language including a data description having a structure complexity into an object oriented data presentation includes identifying the data description and creating an object oriented class including an internal static class, wherein the internal static class corresponds to the structure complexity of the data description.

In accordance with another exemplary embodiment of the present invention, a method for mapping a Schema including a structural complexity into an object oriented language including a functionality to provide a one to one correspondence between the structural complexity of the semantical language and the functionality of the object oriented language includes receiving said Schema, validating said Schema, creating a set of object oriented classes including a set of internal static classes to provide a mapping of the Schema into the object oriented language, creating an instance corresponding to the object oriented classes, compiling the instance to provide an object oriented code and transmitting the object oriented code.

Another aspect of the present invention provides a computer readable medium containing programming which when executed performs the following procedures including: identifying a data description and creating an object oriented class including an internal static class, wherein the internal static class corresponds to a structure complexity of the data description.

Yet another embodiment provides a computer readable medium containing programming for mapping a Schema including a structural complexity into an object oriented language including a functionality to provide a one to one correspondence between the structural complexity of the semantical language and the functionality of the object oriented language which when executed performs the following procedures including: receiving said Schema, validating said Schema, creating a set of object oriented classes including a set of internal static classes to provide a mapping of the Schema into the object oriented language, creating an instance corresponding to the object oriented classes, compiling the instance to provide an object oriented code and transmitting the object oriented code.

Another feature of the present invention is an apparatus for mapping a descriptive language including a data description having a structure complexity into an object oriented data presentation including a means for identifying the data description and a means for creating an object oriented class including an internal static class, wherein the internal static class corresponds to the structure complexity of the data description.

Still other objects, features, and attendant advantages of the present invention will become apparent to those skilled in the art from a reading of the following detailed description of embodiments constructed in accordance therewith, taken in conjunction with the accompanying drawings and appended claims.

### BRIEF DESCRIPTION OF THE DRAWINGS

The invention of the present application will now be described in more detail with reference to preferred embodiments of the apparatus and method, given only by way of example, and with reference to the accompanying drawings, in which:

FIG. 1 illustrates an exemplary instance document written in XML text;

FIG. 2 illustrates an exemplary valid Schema for XML text;

FIG. 3 illustrates an exemplary mapping of a valid Schema into Java using the current state of the art;

FIG. 4 illustrates an exemplary mapping of a valid Schema into Java using the present invention;

FIG. 5 illustrates a flowchart useful in describing an exemplary method for mapping a descriptive language; and

FIG. 6 illustrates a flowchart useful in describing an exemplary method for mapping a Schema into an object oriented language.

### DETAILED DESCRIPTION OF THE PREFERRED EMBODIMENTS

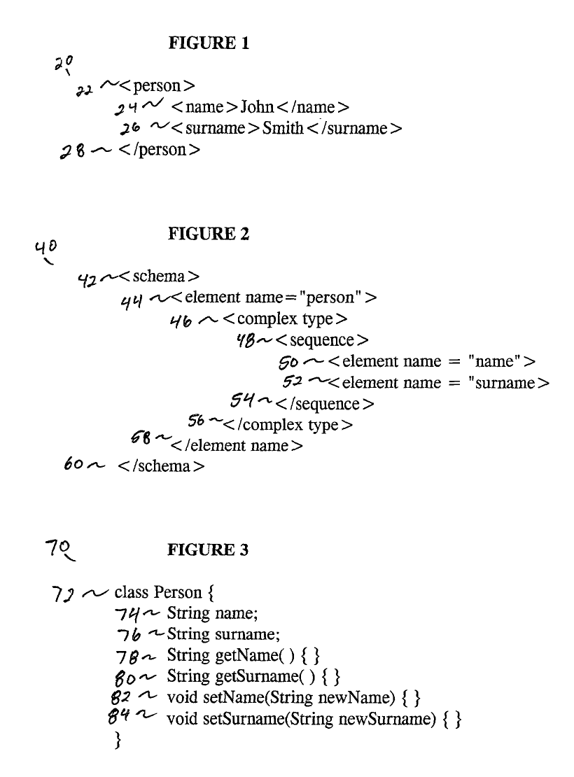

Referring now to the drawings, wherein like reference numerals designate identical or corresponding parts throughout the several views, and more particularly to FIGS. 1-3 which are presented to illustrate the problems corresponding to the prior art.

In FIG. 1 thereof, is illustrated an exemplary instance document written in eXtensible Markup Language (“XML”) text document and generally designated by the numeral 20. An instance is a member of a class. Line 22 is a tag designating the type of class to be a person class. Lines 24 and 26 describe elements within the person class. Line 24 is a declaration of an element of type name containing the data “John”. Line 26 is a declaration of an element of type surname containing the data “Smith”. Line 28 is a tag designating the end of elements defined in the person class. Thus the instance document 20 describes “John Smith” as an instance of the class “person”.

The valid Schema written for the XML text in the instance 20 is illustrated in FIG. 2 and is generally designated by the numeral 40. Line 42 is a declaration defining the XML as Schema, which defines a valid document. The Schema language is an entire standard set forth by the W3C which semantically describes how to write XML text. This term may also refer to a Schema which is not the entire standard but rather a portion of the standard taken by the developer which reflects the semantical structures of a specific XML document. Thus any XML document could be labeled Schema valid or invalid, depending on whether it followed the semantical guidelines set forth in the Schema itself. Line 44 is a definition defining an element name to be “person”. Line 46 declares the type to be a complex type. Line 48 defines the semantical sequencing order, wherein the sequence of the following elements must occur for the XML text to be Schema valid. Line 50 defines the first element name in the sequence to be “name”. Line 52 defines the second element name in the sequence to be “surname”. Line 54 declares an end tag to the sequence, specifying that the elements within the sequence have all been defined. Line 56 declares an end tag for the complex type, specifying that the elements within the complex type are complete. Line 58 declares an end tag for the element name, specifying that the elements within the element name “person” are complete. Line 60 declares an end tag for the Schema, specifying that the Schema semantical description is complete.

The Schema 40 defines a valid document thus any xml document could be labeled Schema valid or invalid. A programmer could attempt to map this description of a valid document into corresponding classes in an object oriented programming language. By way of example and not of limitation, the object oriented programming (OOP) language Java could be used to create a java class named person having two attributes: (1) name; and (2) surname. Within the OOP are accessors and mutators which provide an avenue of access to the instance, such as the accessor get name() and mutator set name().

A Java class of the above valid Schema shown in FIG. 2 can be mapped. FIG. 3 illustrates an exemplary mapping of a valid Schema into Java using the current state of the art. Line 72 declares a Java class of type “Person”. Line 74 defines an element string labeled “name”. Line 76 defines an element string labeled “surname”. The functional aspects of the object oriented language are represented by lines 78-84. Line 78 is a method getName returning data located in the name element. This method is called an accessor since it accesses the data within the element. At line 80, getSurname returns the string located in the surname. Mutators are methods which change the data within the element, such as illustrated in lines 82-84. At line 82, setName sets the string new name into the element name. Line 84, setSurname, sets the string new surname into the elements surname. In such a mapping of the XML Schema into Java, certain elements of the Schema are lost. For example, there is no sequential difference in the Java code for name and surname.

Thus a programmable Java representation of real data is created. However, even though the valid XML Schema can be mapped, some aspects of the Schema are lost. The problems arise because the relational aspects of the descriptive languages, such as sequence and assimilation, are not present in OOP. Likewise, the accessors and mutators, i.e. “get” and “set” methods for example, contained within the OOP do not exist in relational databases.

The problem is emphasized here when attempting to access the data instance once mapped into the code. For example, when an accessor such as in line 78 and line 80 (getName and getSurname respectively) are called, a string is returned. This string does not contain the relationship of the return object, which is a string, to the person the name belongs to. It only contains the string itself without any relation to the person. There is no sequential difference in the Java code for name and surname. As soon as you get the name out of Person, you have lost the knowledge that it is a name and not a surname, or vice versa. The Schema semantical representation of the data is no longer present.

The present invention solves the problems outlined above by providing a method and apparatus for mapping a descriptive language including a data description having a structure complexity into an object oriented data presentation includes identifying the data description and creating an object oriented class including an internal static class, wherein the internal static class corresponds to the structure complexity of the data description.

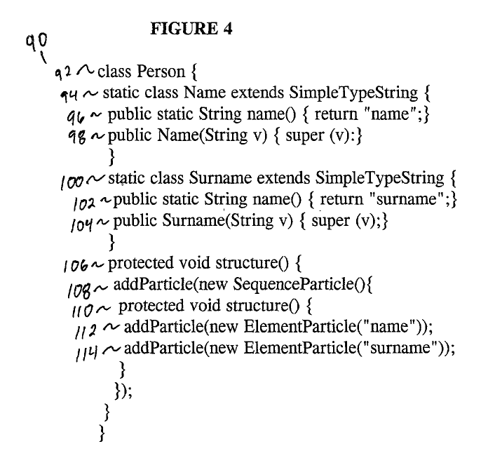

Now referring to FIG. 4, there is illustrated an exemplary mapping of a valid Schema into Java using the present invention and is generally designated by the numeral 90. By way of example and not limitation, the Schema represented in FIG. 2 is compiled into the object oriented language of Java. The method retains the relational complexities of the Schema 40 by introducing an internal static class. In order to describe the internal elements related to the higher element of hierarchy, static classes are used inside the upper class. For example, in mapping a Schema which describes an element name person, the internal static class will become part of the class Person.

Line 92 declares a class of type Person. Line 94 defines an internal static class Name. Within the internal static class 94, a static method name( ) is present as indicated at 96. Also within the internal static class 94, there is a constructor 98 which takes string as a parameter. Once the constructor 98 is invoked, the object of Name class is created. Thus the actual namespacing integrity is preserved. Line 100 designates the creation of the internal static class Surname. Within the internal static class 100, a static method name( ) is present as indicated at 102. Also within the internal static class 100 there is a constructor 104 which takes string as a parameter. Once the constructor 104 is invoked, the object of Surname class is created. Thus, as detailed above, the actual namespacing integrity is preserved. Line 106 begins a definition of a method structure( ), which is responsible for “building” the object of a class Person. As line 108 indicates, this method consists of a single statement, namely an invocation of a method addParticle( ), passing a new instance of SequenceParticle as a parameter. Line 110 shows that method structure( ) is overloaded for the SequenceParticle instance. As lines 112 and 114 indicate, overloaded structure( ) method consists of two statements, each adding particle of ElementParticle type. In line 112, name is added. Then in line 114, surname is added.

A namespace identifies the names of particular data elements or attributes used within an XML file for example. It is a unique name that identifies an organization that has developed an XML Schema. By way of example, it serves as a prefix so that multiple Schemas can be used to define tags in an XML document.

The usage to create a name is as follows: new Person.Name (“John”) gives the name class not the string anymore. It is a name spacing not just a string and means something different in Person class than another class, say for example a automobile class. The relations between the name and the surname are retained. As soon as the class is filled, it becomes an instance of the class. The program using it, after going through its accessors, will have the name content and know that it is a name, rather than a surname or another element because it has a type, a Name type.

The internal static class is introduced within the Person class because since it is inside the Person, the particular name class relates solely to the particular Person. If there are other relations present, such as other people, they will be hidden because they will have their name inside. Combining name and surname will result in the full semantic of this Person. The class must be static because otherwise the instance of the internal class is not related to the specific instance of the upper class. The result is that there isn't direct access to the name portion and can only be retrieved through the particular class.

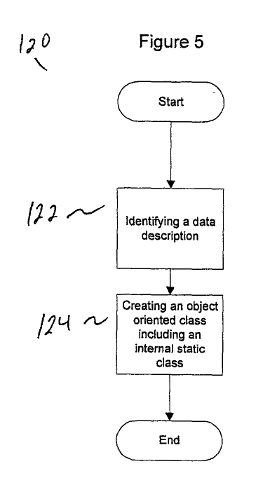

Now referring to FIG. 5, there is illustrated a flowchart useful in describing an exemplary method for mapping a descriptive language and generally designated as numeral 120. The descriptive language may include a data description having a structure complexity into an object oriented data presentation. By way of example and not by limitation, a descriptive language may be a semantically declarative language such as Schema or XML Schema. The data description may include structural complexity constructs such as sequencing or amount of elements. The object oriented data presentation may be any data presentation that is organized around objects rather than actions, data rather than logic. By way of example and not by limitation, programming languages such as Java, C++ and Smalltalk may be used.

Method 120 begins with identifying the data description, as indicated at 122. The data description may be a semantical representation of the data. For purposes of example, the Schema 40 represents a Schema of a “Person”. As such, the data description would be describing the semantics of the data element “Person”. It is a complex type, as indicated at 46, with a relational characteristic of sequencing, as indicated at 48. Once the data description is identified, an object oriented class is created, as indicated at 124. The object oriented class may include an internal static class which corresponds to the structure complexity of the data description.

The first step in object oriented programming is identifying all the objects that are going to be manipulated and how they relate to each other, an exercise well known in the art as data modeling. Once the objects are identified, it is generalized in an object oriented class. The object oriented class has a certain kind of data within each particular class and any logic sequences used in data manipulation. Each distinct logic sequence is known as a “method”. Examples of such are illustrated in lines 78-84 of FIG. 3 and lines 98, 100, 106 and 108 of FIG. 4. A real instance of a class is called an object or instance of a class and is what is run on a computer.

Another feature of the present invention may include representing a naming space with said internal static class to provide an implementation of the structure complexity. Examples of internal static classes are illustrated in FIG. 4 at lines 94 and 102. Optionally, the internal static class may be a subclass of a data object. Method 120 may also include the step of receiving a Schema for an XML text.

Identifying the data description 122 may also include validating a Schema. In such validation, the Schema includes a class description to provide the creation of an instance of a compiler class corresponding to the class description. If it is possible to create an instance out of a compiler class which is described in the Schema itself, then the Schema may be validated.

Another exemplary method of validating a Schema includes using a object finite state machine. The state machine may include a current state to verify a mutator method call against the current state of the object. Once a specific object has been created, other object oriented structures can be used to describe the state of the class. A state may be associated with a class and the validness of the instance may be checked by inquiry into what state the class is currently in at a particular moment. If the class is filled up, then it can be used for future processing. If the class is not full, then it is invalid. This allows the developer to obtain a solution to the sequencing problem. By way of example and not by limitation, a mutator set name is called. Then a validity check is performed by calling a method is_valid_method. Since surname has not yet been set, the class returns not valid. Both the name and surname must be set before a second set name may be called. Therefore, the Schema is invalid when the mutator method call is initiated before the current state is complete.

Another example of validating includes the steps of sending a request including a Schema from a user to a remote server and retrieving a validity determination as to said Schema. The user would input his/her Schema as data and the remote server would retrieve the data, manipulate it by determining whether it is Schema valid or not and then return the validity determination. Another aspect of the present invention is that once the Schema data is validated, it is then mapped into an object oriented code. The mapped code is then returned to the user.

Yet another example of validating the Schema includes the steps of reading the Schema into a set of valid Schema descriptor classes and creating a set of objects out of the Schema wherein the occurrence of an object reflects validity. This process operates on the premise that if an instance of the Schema already exists, an object can be created and thus the Schema is valid.

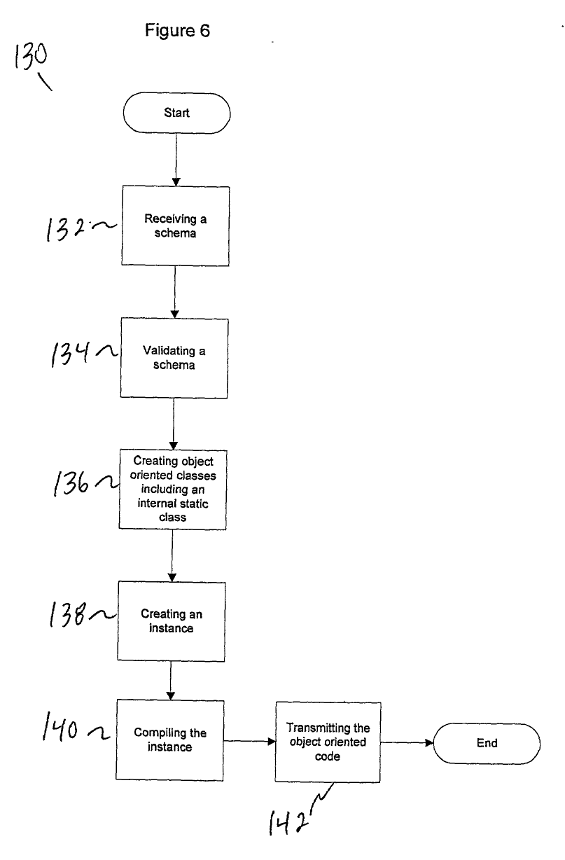

Referring now to FIG. 6 which illustrates a flowchart useful in describing an exemplary method for mapping a Schema into an object oriented language and is generally designated by the numeral 130. The method 130 may include a structural complexity as described above and an object oriented functionality, such as accessors and mutators, to provide a one to one correspondence between the structural complexity of the semantical language and the functionality of the object oriented language. Method 130 begins by receiving a Schema, as indicated at 132. The Schema may define a complex data structure. By way of example and not limitation, the Schema may be an XML Schema. An example of a Schema is shown in FIG. 2.

Next the Schema is validated, as indicated at 134. In such validation, the Schema includes a class description to provide the creation of an instance of a compiler class corresponding to the class description. If it is possible to create an instance out of a compiler class which is described in the Schema itself, then the Schema may be validated.

Another exemplary method of validating a Schema includes using a object finite state machine. The state machine may include a current state to verify a function call against the current state of the object. Once a specific object has been created, other object oriented structures can be used to describe the state of the class. A state may be associated with a class and the validness of the instance may be checked by inquiry into what state the class is currently in at a particular moment. If the class is filled up, then it can be used for future processing. If the class is not full, then it is invalid. This allows the developer to obtain a solution to the sequencing problem. By way of example and not by limitation, a mutator set name is called. Then a validity check is performed by calling a function is_valid_method. Since surname has not yet been set, the class returns not valid. Both the name and surname must be set before a second set name may be called. Therefore, the Schema is invalid when the function call is initiated before the current state is complete.

Another example of validating includes the steps of sending a request including a Schema from a user to a remote server and retrieving a validity determination as to said Schema. The user would input his/her Schema as data and the remote server would retrieve the data, manipulate it by determining whether it is Schema valid or not and then return the validity determination. Another aspect of the present invention is that once the Schema data is validated, it is then mapped into an object oriented code. The mapped code is then returned to the user.

Yet another example of validating the Schema includes the steps of reading the Schema into a set of valid Schema descriptor classes and creating a set of objects out of the Schema wherein the occurrence of an object reflects validity. This process operates on the premise that if an instance of the Schema already exists, an object can be created and thus the Schema is valid.

The next step is creating a set of object oriented classes including a set of internal static classes to provide a mapping of the Schema into the object oriented language, as indicated at 136. One embodiment of the present invention includes fully implementing all the requirements of the Schema by mapping the entire Schema into an object oriented programming language through the use of internal static classes. The object oriented class has a certain kind of data within each particular class and any logic sequences used in data manipulation. Each distinct logic sequence is known as a “method”. Examples of such are illustrated in lines 78-84 of FIG. 3 and lines 98, 100, 106 and 108 of FIG. 4.

Another feature of the present invention may include representing a naming space with said internal static class to provide an implementation of the structure complexity. Examples of internal static classes are illustrated in FIG. 4 at lines 94 and 102. Optionally, the internal static class may be a subclass of a data object.

Next an instance corresponding to the object oriented classes is created, as indicated at 138. The real instance of a class is called an object or instance of a class and is what is run on a computer. In an embodiment, creating the instance of the internal static subclasses provides for the full description of any data descriptive language, such as Schema for example.

As indicated at 140, the instance is then compiled to provide an object oriented code. By way of example and not limitation, the object oriented code may be Java, C++ or Smalltalk. Next the object oriented code is transmitted, as indicated at 142.

While there has been described what are believed to be exemplary embodiments of the present invention, those skilled in the art will recognize that other and further changes and modifications may be made thereto without departing from the scope of the invention which is defined by the appended claims, and it is intended to claim all such changes and modifications as fall within the true scope of the invention.

What is claimed is:

1. A method for mapping a descriptive language including a data description having a structure complexity into an object oriented data presentation, comprising the steps of:
identifying the data description; and
creating an object oriented class including an internal static class, wherein the internal static class corresponds to the structure complexity of the data description.

2. The method as recited in claim 1, wherein said method further comprises receiving a Schema for an XML text.

3. The method as recited in claim 1, wherein said identifying includes validating a Schema including a class description to provide the creation of an instance of a compiler class corresponding to the class description.

4. The method as recited in claim 3, wherein said validating includes using a object finite state machine including a current state to verify a mutator method call against the current state of the object, wherein the Schema is invalid when the mutator method call is initiated before the current state is complete.

5. The method as recited in claim 3, wherein said validating includes:
sending a request including said Schema from a user to a remote server; and
retrieving a validity determination as to said Schema.

6. The method as recited in claim 3, wherein said validating includes:
reading said Schema into a set of valid Schema descriptor classes; and
creating a set of objects out of the Schema wherein the occurrence of an object reflects validity.

7. The method as recited in claim 1, wherein said creating includes a set of object oriented classes selected from the group consisting of: Java, C ++ and Smalltalk.

8. The method as recited in claim 1, wherein said creating includes representing a naming space with said internal static class to provide an implementation of said structure complexity.

9. A method for mapping a Schema including a structural complexity into an object oriented language including a functionality to provide a one to one correspondence between the structural complexity of the semantical language and the functionality of the object oriented language, comprising the steps of:
receiving said Schema;
validating said Schema;
creating a set of object oriented classes including a set of internal static classes to provide a mapping of the Schema into the object oriented language;
creating an instance corresponding to the object oriented classes;
compiling the instance to provide an object oriented code; and
transmitting the object oriented code.

10. The method as recited in claim 9, wherein said validating includes using a object finite state machine including a current state to verify a function call against the current state of the object, wherein the Schema is invalid when the function call is initiated before the current state is complete.

11. The method as recited in claim 9, wherein said validating includes:
sending a request including said Schema from a user to a remote server; and
retrieving a validity determination as to said Schema.

12. The method as recited in claim 9, wherein said validating includes:
reading said Schema into a set of valid Schema descriptor classes; and
creating an instance of a compiler class wherein the compiler class is described in the Schema.

13. The method as recited in claim 9, wherein said creating a set of object oriented classes includes selected from the group consisting of: Java, C++ and Smalltalk.

14. The method as recited in claim 9, wherein said creating an instance includes representing a naming space with the internal static class to provide an implementation of said structural complexity.

15. A computer readable medium containing programming which when executed performs the following procedures comprising:
identifying a data description; and
creating an object oriented class including an internal static class, wherein the internal static class corresponds to a structure complexity of the data description.

16. The medium as recited in claim 15, wherein said medium further performs the procedure receiving a Schema for an XML text.

17. The medium as recited in claim 15, wherein said identifying procedure includes validating a Schema including a class description to provide the creation of an instance of a compiler class corresponding to the class description.

18. The medium as recited in claim 17, wherein said validating procedure includes using a object finite state machine including a current state to verify a mutator method call against the current state of the object, wherein the Schema is invalid when the mutator method call is initiated before the current state is complete.

19. The medium as recited in claim 17, wherein said validating procedure includes:
sending a request including said Schema from a user to a remote server;
retrieving a validity determination as to said Schema.

20. The medium as recited in claim 17, wherein said validating procedure includes:
reading said Schema into a set of valid Schema descriptor classes; and
creating a set of objects out of the Schema wherein the occurrence of an object reflects validity.

21. The medium as recited in claim 15, wherein said creating procedure includes a set of object oriented classes selected from the group consisting of: Java, C++ and Smalltalk.

22. The medium as recited in claim 15, wherein said creating procedure includes representing a naming space with said internal static class to provide an implementation of said structure complexity.

23. A computer readable medium containing programming for mapping a Schema including a structural complexity into an object oriented language including a functionality to provide a one to one correspondence between the structural complexity of the semantical language and the functionality of the object oriented language which when executed performs the following procedures comprising:
receiving said Schema;
validating said Schema;
creating a set of object oriented classes including a set of internal static classes to provide a mapping of the Schema into the object oriented language;
creating an instance corresponding to the object oriented classes;
compiling the instance to provide an object oriented code; and
transmitting the object oriented code.

24. The medium as recited in claim 23, wherein said validating procedure includes using a object finite state machine including a current state to verify a function call against the current state of the object, wherein the Schema is invalid when the function call is initiated before the current state is complete.

25. The medium as recited in claim 23, wherein said validating procedure includes:
sending a request including said Schema from a user to a remote server; and
retrieving a validity determination as to said Schema.

26. The medium as recited in claim 23, wherein said validating procedure includes:
reading said Schema into a set of valid Schema descriptor classes; and
creating an instance of a compiler class wherein the compiler class is described in the Schema.

27. The medium as recited in claim 23, wherein said creating a set of object oriented classes procedure includes an object oriented language selected from the group consisting of: Java, C++ and Smalltalk.

28. The medium as recited in claim 23, wherein said creating an instance procedure includes representing a naming space with the internal static class to provide an implementation of said structural complexity.

29. An apparatus for mapping a descriptive language including a data description having a structure complexity into an object oriented data presentation comprising:
means for identifying the data description; and
means for creating an object oriented class including an internal static class, wherein the internal static class corresponds to the structure complexity of the data description.

30. The apparatus as recited in claim 29, wherein said apparatus further comprises means for receiving a Schema for an XML text.

31. The apparatus as recited in claim 29, wherein said identifying means includes means for validating a Schema including a class description to provide the creation of an instance of a compiler class corresponding to the class description.

32. The apparatus as recited in claim 29, wherein said validating means includes a object finite state machine including a current state to verify a mutator method call against the current state of the object, wherein the Schema is invalid when the mutator method call is initiated before the current state is complete.

33. The apparatus as recited in claim 29, wherein said validating means includes a web browser to send a request including said Schema from a user computer to a remote server, in response to said request, said Schema being validated.

34. The apparatus as recited in claim 29, wherein said validating means includes:
means for reading said Schema into a set of valid Schema descriptor classes; and
means for creating a set of objects out of the Schema wherein the occurrence of an object reflects validity.

35. The apparatus as recited in claim 29, wherein said creating means includes a set of object oriented classes selected from the group consisting of: Java, C ++and Smalltalk.

36. The apparatus as recited in claim 29, wherein said creating means includes means for representing a naming space with said internal static class to provide an implementation of said structure complexity.
